(19) United States
(12) Patent Application Publication
(10) Pub. No.: US 2008/0042631 A1
(43) Pub. Date: Feb. 21, 2008

(54) SWITCHING POWER SUPPLY

(75) Inventors: SHIH-FANG WONG, Tu-Cheng (TW); TAI-CHUN LI, Shenzhen (CN); JUN LI, Shenzhen (CN); JUN ZHANG, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/840,228

(22) Filed: Aug. 17, 2007

(30) Foreign Application Priority Data
Aug. 18, 2006 (CN) 200610062208.1

(51) Int. Cl. G05F 1/44

(52) U.S. Cl. 323/283

(57) ABSTRACT

A switching power supply includes an amplitude control circuit (30) connected between an alternating current (AC) source (10) and a traditional switching power supply (20). The amplitude control circuit includes a power switch (31) and a pulse generator (32). The power switch is connected between the AC source and the traditional switching power supply and is configured for conducting power to the traditional switching power supply when enabled, and the pulse generator is configured for generating rectangular pulses to enable and disable the power switch in an alternating manner.

### BACKGROUND

1. Technical Field

The present invention relates to switching power supplies, and particularly to a switching power supply with amplitude control.

2. Related Art

A switching power supply is generally required to have a stable output when at full-load and should reduce power loss at no-load or light-load. Power loss reduction of switching power supplies is achieved by reducing power losses of power switches and chokes (e.g., transformers) included in the switching power supplies However, improving the power switches and chokes or associated circuitry is complex and costly.

Therefore, there is a need for providing a novel switching power supply which can reduce power loss with a simple structure.

### SUMMARY

A switching power supply is provided in accordance with a preferred embodiment of the present invention. The switching power supply includes an amplitude control circuit connected between an alternating current (AC) source and a traditional switching power supply. The amplitude control circuit includes a power switch and a pulse generator. The power switch is connected between the AC source and the traditional switching power supply and is configured for conducting power to the traditional switching power supply when enabled, and the pulse generator is configured for generating rectangular pulses to enable and disable the power switch in an alternating manner.

Other advantages and novel features will be drawn from the following detailed description with reference to the attached drawings.

### BRIEF DESCRIPTION OF THE DRAWINGS

FIG. 1 is a block diagram of a switching power supply in accordance with a preferred embodiment of the present invention.

### DETAILED DESCRIPTION OF THE EMBODIMENTS

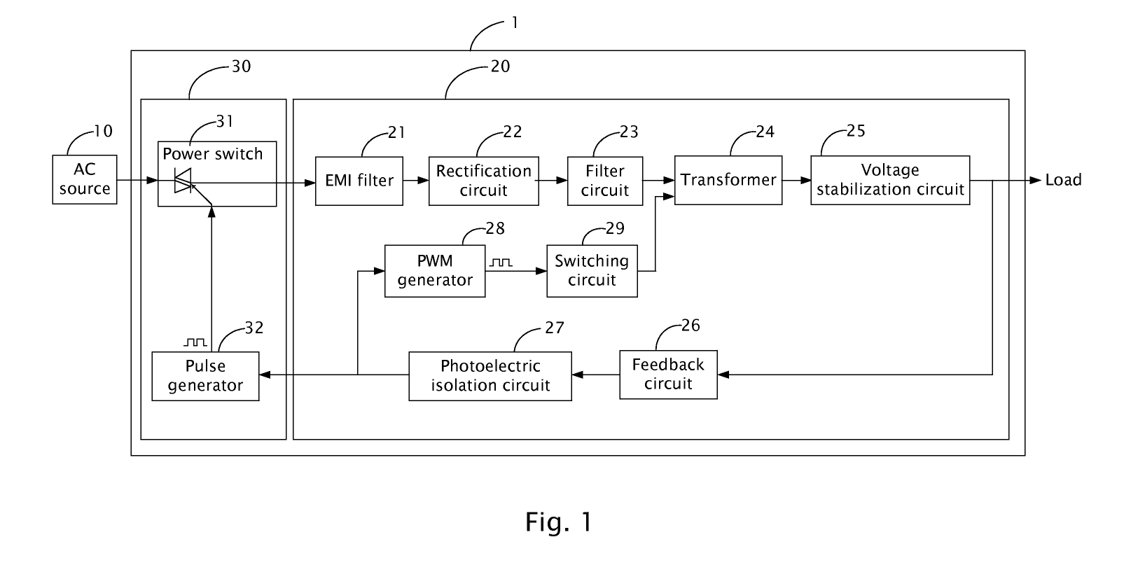

Referring to FIG. 1, a block diagram of a switching power supply in accordance with a preferred embodiment of the present invention is shown. The switching power supply 1 is developed from a traditional switching power supply 20 and includes an amplitude control circuit 30 and the traditional switching power supply 20. The amplitude control circuit 30 is configured for transferring electricity power from an alternating current (AC) source 10 to the traditional switching power supply 20. The traditional switching power supply 20 generally includes an electromagnetic interference (EMI) filter 21, a rectification circuit 22, a filter circuit 23, a transformer 24, and a voltage stabilization circuit 25. The EMI filter 21, the rectification circuit 22, the filter circuit 23, the transformer 24 and the voltage stabilization circuit 25 are connected in series in that order, and are used to supply power to loads. A feedback circuit 26 feeds back information on output power (hereinafter “the feedback information”) to a pulse width modulation (PWM) generator 28 via a photoelectric isolation circuit 27. The PWM generator 28 generates PWM signals according to a comparison result of the feedback information with a first preset value and the PWM signals are used to enable and disable a switching circuit 29 in an alternating manner to control power conversion of the transformer 24.

The feedback information is also fed back to the amplitude control circuit 30. The amplitude control circuit 30 includes a power switch 31 and a pulse generator 32. The pulse generator 32 can be a PWM pulse generator or a pulse frequency modulation (PFM) pulse generator, or the like. The pulse generator 32 generates rectangular pulses according to a comparison result of the feedback information and a second preset value. In the preferred embodiment, the first preset value and the second preset value both reflect a desired output to the loads. The first and second preset values may or may not be equal to each other. The rectangular pulses are used to enable and disable the power switch 31 in an alternating manner, thus to control the power to the traditional switching power supply 20 from the AC source 10.

The power switch 31 can be a triode alternating current switch (TRIAC) that has a gate electrode controlled by the pulse generator 32 by use of the rectangular pulses.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A switching power supply comprising an amplitude control circuit connected between an alternating current (AC) source and a traditional switching power supply, the amplitude control circuit comprising:
a power switch configured for conducting power to the traditional switching power supply when switched on; and
a pulse generator configured for generating rectangular pulses to control the power switch.

2. The switching power supply as claimed in claim 1, wherein the power switch is a triode alternating current switch that has a gate electrode controlled by the pulse generator.

3. The switching power supply as claimed in claim 1, wherein the pulse generator is a pulse width modulation (PWM) pulse generator.

4. The switching power supply as claimed in claim 1, wherein the pulse generator is a pulse frequency modulation (PFM) pulse generator.

5. The switching power supply as claimed in claim 1, wherein the pulse generator receives feedback information from a feedback circuit and generating the rectangular pulses according to a comparison result of the feedback information with a preset value.

6. The switching power supply as claimed in claim 5, wherein the preset value reflects a desired output of the switching power supply.
